(19) United States
(12) Patent Application Publication
(10) Pub. No.: US 2017/0311566 A1
(43) Pub. Date: Nov. 2, 2017

(54) MOBILE LIMITED RESTRAINT FOR ANIMALS

(71) Applicant: Wilson Grant Wells, Chapin, SC (US)

(72) Inventor: Wilson Grant Wells, Chapin, SC (US)

(21) Appl. No.: 15/583,945

(22) Filed: May 1, 2017

Related U.S. Application Data
(60) Provisional application No. 62/329,337, filed on Apr. 29, 2016.

(51) Int. Cl. A01K 1/04; A01K 27/00

(52) U.S. Cl. CPC A01K 1/04; A01K 27/004

(57) ABSTRACT

An animal restraint is provided. The animal restraint includes an elongated rod having a top end and a bottom end. A head mount includes a mount post and a bracket extending from the mount post. The mount post is slidably attached to the top end of the elongated rod. The mount post is rotatable relative to the elongated rod about a longitudinal axis of the elongated rod. The present invention further includes a retractable leash. The retractable leash is secured to the bracket. The retractable leash includes a housing and a leash operable to extend from and retract within the housing. A hook is attached to an end of the leash.

### CROSS-REFERENCE TO RELATED APPLICATION

This application claims the benefit of priority of U.S. provisional application No. 62/329,337, filed Apr. 29, 2016, the contents of which are herein incorporated by reference.

### BACKGROUND OF THE INVENTION

The present invention relates to keeping animals in a restrained area and, more particularly, to a mobile limited restraint for animals.

Grazing is a method of feeding in which horses and other animals feed on plants such as grass. In an open area, horse owners may attempt to temporarily restrain the animal within a certain area. Current forms of restraints are susceptible to being broken by the horse by stepping on the leash as well as being entangled causing harm to the animal. Other restraints are not kept off the ground and thereby do not prevent entanglement.

As can be seen, there is a need for an elevated restraint for animals, such as horses.

### SUMMARY OF THE INVENTION

In one aspect of the present invention, an animal restraint comprises: an elongated rod comprising a top end and a bottom end; a head mount comprising a mount post and a bracket extending from the mount post, wherein the mount post is slidably attached to the top end and is rotatable relative to the elongated rod about a longitudinal axis of the elongated rod; a retractable leash secured to the bracket, wherein the retractable leash comprises a housing and a leash operable to extend from and retract within the housing; and a hook secured to the end of the leash.

In another aspect of the present invention, an animal restraint comprises: an elongated rod comprising a top end, a bottom end, an upper slide stop and a lower slide stop, wherein a slide hammer slidably engages the elongated rod in between the upper slide stop and the lower slide stop; a head mount comprising a mount post and a bracket extending from the mount post, wherein the mount post is slidably attached to the top end and is rotatable relative to the elongated rod about a longitudinal axis of the elongated rod; a retractable leash secured to the bracket, wherein the retractable leash comprises a housing and a leash operable to extend from and retract within the housing; and a hook secured to the end of the leash.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use;

FIG. 2 is a perspective view of an embodiment of the present invention;

FIG. 3 is an exploded view of an embodiment of the present invention;

FIG. 4 is a section view of the present invention taken along line 4-4 in FIG. 1;

FIG. 5 is an enlarged section view of an embodiment of the present invention;

FIG. 6 is an enlarged section view of an embodiment of the present invention;

FIG. 7 is a section view of the present invention taken along line 7-7 in FIG. 4; and

FIG. 8 is a top view of the present invention illustrating a 360-degree movement.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a mobile limited restraint for horses or smaller animals. The present invention is a device that allows animals to be mobile, but limited in restraint for grazing, horse shows, rodeos, and special events. The present invention is designed for safety to humans that are in the vicinity of the horse. The present invention provides mobility and safety and because of its design prevents the horse from breaking the leash or becoming entangled. The present invention puts the restraining device at or above eye level for the horse preventing the animal from stepping on it and/or becoming entangled.

The present invention includes is a long metal rod, such as steel, designed to be driven into the ground by a slide hammer. The slide hammer may include a cylinder shaped with a hollow core along the longitudinal axis. The slide hammer is slid onto the rod and metal stops are welded above and below the slide hammer to keep it on the steel rod. To install, the steel rod is pounded into the ground. Sliding the slide hammer against the lower metal stop may further aid in driving the rod into the ground. To remove the rod from the ground, the slide hammer may be slid against the upper metal stop. The steel rod may include a blunt top end or tip to make it easier to drive into the ground.

The present invention further includes a spring loaded retractable cable, cord or nylon webbing that swivels 360 degrees at the top of the rod. The leash may stretch out to 16′ in length. The retractable cable housing may slide off the end of the pole as a safety release. At the end of the cable, cord or nylon webbing that attaches to the animal is another safety release device. The retractable cable, cord or nylon webbing swiveling device is simply slid onto the top of the steel rod. When the rod is driven into the ground, the retractable cable housing may be about 5′ to 6′ tall above the ground.

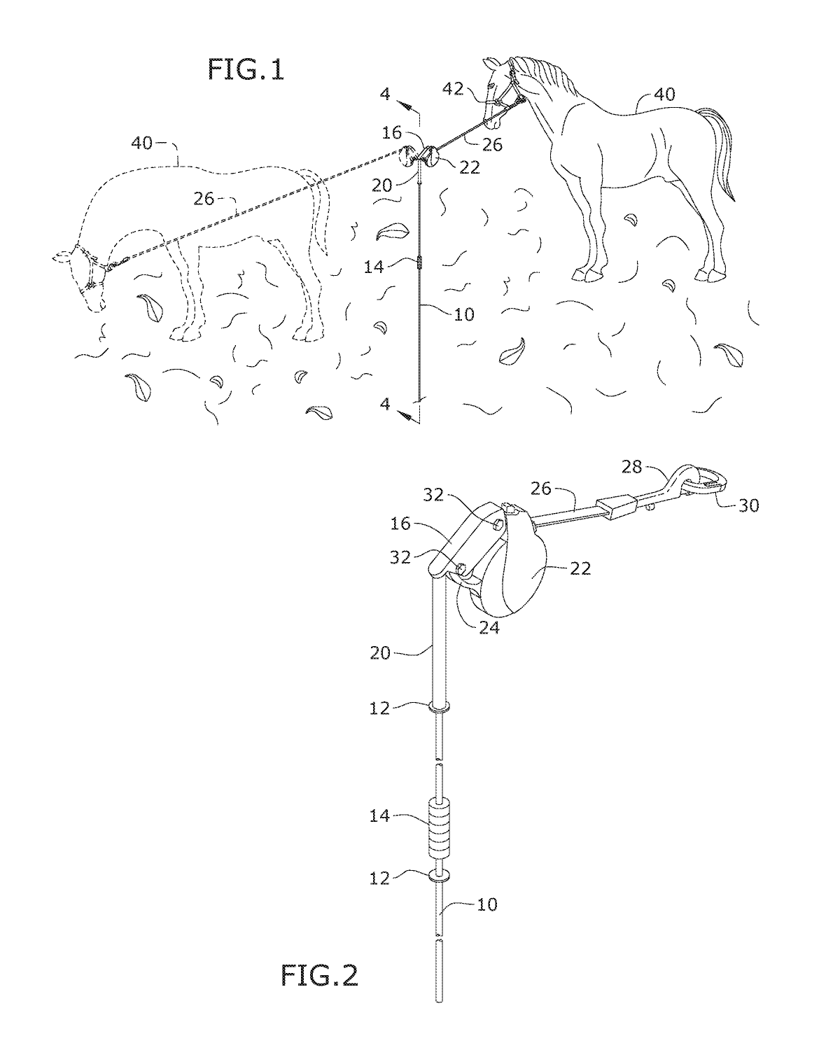

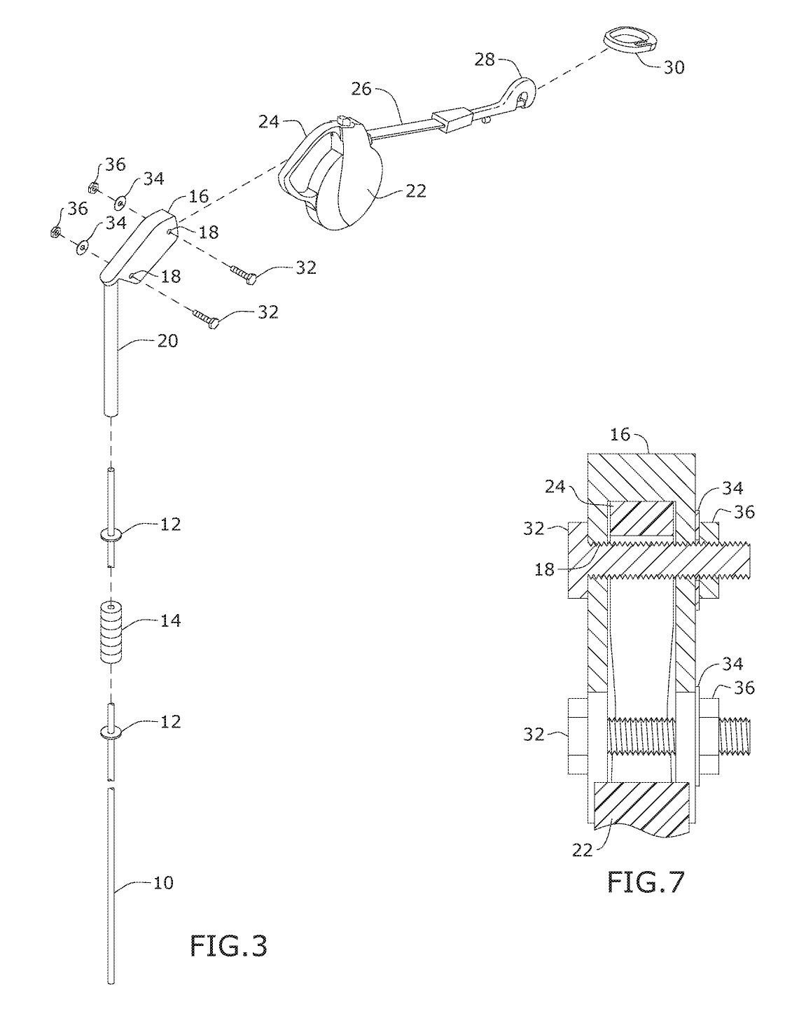

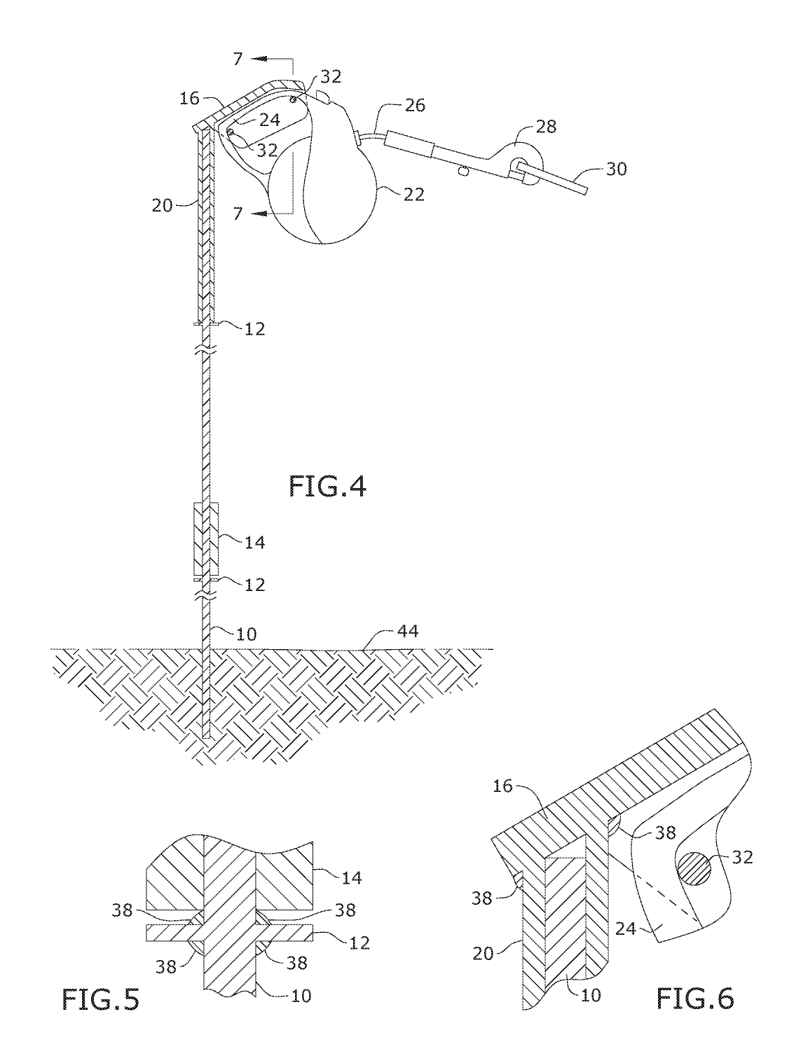

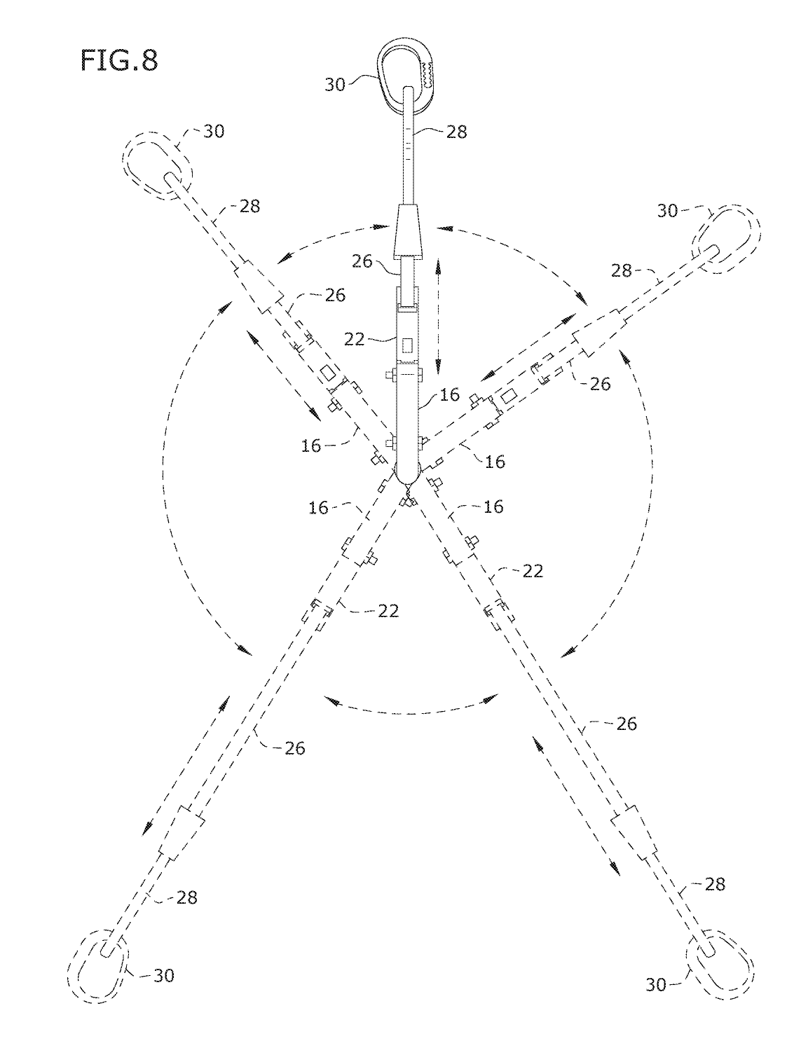

Referring to FIGS. 1 through 8, the present invention includes an animal restraint. The animal restraint includes an elongated rod 10 having a top end and a bottom end. A head mount 15 includes a mount post 20 and a bracket 16 extending from the mount post 20. The mount post 20 is slidably attached to the top end of the elongated rod 10. The mount post 20 is rotatable relative to the elongated rod 10 about a longitudinal axis of the elongated rod 10. The present invention further includes a retractable leash 21. The retractable leash 21 is secured to the bracket 16. The retractable leash 21 includes a housing 22 and a leash 26 operable to extend from and retract within the housing 22. A hook 28, such as a spring latch hook, is attached to an end of the leash 26.

In certain embodiments, the mount post 20 includes a hollow center along its longitudinal axis. The top end of the elongated rod 10 slides into the hollow center of the mount post 20. The mount post 20 may rotate 360 degrees relative to the elongated rod 10.

The bracket 16 of the present invention may extend laterally from the top end of the mount post 20. The bracket 16 may include extending arms, each having aligned openings 18. A handle 24 of the retractable leash 21 may fit in between the arms. Bolts 32 may run through the aligned openings 18 and washers 34 and nuts 36 may secure to the distal ends of the bolts 32. The handle 24 is secured in between the arms, the bolts 32 and a top portion of the bracket 16, thereby securing the retractable leash 21 to the bracket 16.

The present invention may further include a safety tie 30. The hook 28 may hook onto the safety tie 30 and the safety tie 30 may secure to the halter 42 of the house 40. The safety tie 30 breaks from the hook 28 if the horse 40 applies a certain amount of force Therefore, if the horse 40 is spooked and begins to run, the horse 40 breaks free from the animal restraint without risking injury. Further, since the mount post 20 slides on the top end of the elongated rod 10, the mount post 20 may also slide off in case the horse 40 begins to run outside of the restricted area.

The elongated rod 10 may further include an upper slide stop 12 and a lower slide stop 12 welded 38 in between the top and bottom ends. A slide hammer 14 is slidably engaged the elongated rod 10 in between the upper slide stop 12 and the lower slide stop 12. The slide hammer 14 may include a cylinder shape with a hollow core along the longitudinal axis of the cylinder shape. The slide stops 12 include a diameter greater than the diameter of the hollow core, thereby preventing the slide hammer 14 from sliding beyond the slide stops 12. A user may drive the elongated rod 10 into the ground 44 and remove the elongated rod 10 from the ground 44 using the slide hammer 14.

A method of using the present invention may include the following. Position the rod in a safe area away from debris, sudden loud noises or anything that would cause entanglement or harm to the animal. The rod may be driven into the ground approximately 1½′ to 2′. After the rod is driven into the ground to the appropriate depth, slide the swiveling, retractable, spring loaded cord (leash) onto the top of the rod. Attach the end of the retractable cord with the safety release onto the animal's halter or collar. Walk the horse or smaller animal to the end of the retractable cord, stretching the cord to its full length. Keeping the cord (leash) taught at its full length, walk the animal around the full circumference of the area 3-5 times. This will help the animal understand that there is a limitation of area. Then let go of the animal while the cord (leash) is at its full length. This will also help demonstrate to the animal that the cord (leash) is at its full length. Remain in sight of the animal for as long as necessary to comfort the animal and ensure the animal can be restrained by the device. The present invention may be a limited restraint device and is designed with two safety releases to detach if the animal is spooked or is not trained for a leash, halter or bridal. Once the animal is comfortable with the device, continue to check on the animal periodically for safety or re-positioning. When removing or re-positioning the device, detach the animal from the cord (leash) and secure the animal in a safe manner. Remove the swiveling, retractable cord from the top of the rod. Using the slide hammer in an opposite manner used to drive the rod into the ground, slide the slide hammer upward pounding the steel rod out of the ground. Re-position as described above or store in a safe place.

It should be understood, of course, that the foregoing relates to exemplary embodiments of the invention and that modifications may be made without departing from the spirit and scope of the invention as set forth in the following claims.

What is claimed is:

1. An animal restraint comprising:
an elongated rod comprising a top end and a bottom end;
a head mount comprising a mount post and a bracket extending from the mount post, wherein the mount post is slidably attached to the top end and is rotatable relative to the elongated rod about a longitudinal axis of the elongated rod;
a retractable leash secured to the bracket, wherein the retractable leash comprises a housing and a leash operable to extend from and retract within the housing; and
a hook secured to an end of the leash.

2. The animal restraint of claim 1, wherein the mount post comprises a hollow center, wherein the top end of the elongated rod is disposed within the hollow center.

3. The animal restraint of claim 1, wherein the retractable leash further comprises a handle secured to the bracket by nuts and bolts.

4. The animal restraint of claim 1, wherein the hook is a latch hook lock.

5. The animal restraint of claim 1, further comprising a safety tie attached to the hook.

6. The animal restraint of claim 1, wherein the head mount rotates 360 degrees relative to the elongated rod.

7. The animal restraint of claim 1, wherein the elongated rod further comprises an upper slide stop and a lower slide stop, wherein a slide hammer slidably engages the elongated rod in between the upper slide stop and the lower slide stop.

8. An animal restraint comprising:
an elongated rod comprising a top end, a bottom end, an upper slide stop and a lower slide stop, wherein a slide hammer slidably engages the elongated rod in between the upper slide stop and the lower slide stop;
a head mount comprising a mount post and a bracket extending from the mount post, wherein the mount post is slidably attached to the top end and is rotatable relative to the elongated rod about a longitudinal axis of the elongated rod;
a retractable leash secured to the bracket, wherein the retractable leash comprises a housing and a leash operable to extend from and retract within the housing; and
a hook secured to an end of the leash.

9. The animal restraint of claim 8, wherein the mount post comprises a hollow center, wherein the top end of the elongated rod is disposed within the hollow center.

10. The animal restraint of claim 8, wherein the head mount rotates 360 degrees relative to the elongated rod.
